(19) United States
(12) Patent Application Publication
(10) Pub. No.: US 2012/0096847 A1
(43) Pub. Date: Apr. 26, 2012

(54) WATER WAVE ENERGY CONVERTER

(75) Inventors: Nicholas Boyd, Victoria (AU); Martin George Buden, Victoria (AU)

(73) Assignee: AQUAGEN TECHNOLOGIES PTY LTD, Victoria (AU)

(21) Appl. No.: 13/321,004

(22) PCT Filed: May 20, 2010
(86) PCT No.: PCT/AU2010/000588

§ 371 Date: Dec. 16, 2011

(30) Foreign Application Priority Data
May 20, 2009 (AU) 2009902294
Sep. 9, 2009 (AU) 2009904319

(51) Int. Cl. F03B 13/16

(52) U.S. Cl. 60/497

(57) ABSTRACT

A water wave-based energy conversion system comprising: at least one buoyant body capable of floating on or below the surface of a body of water; at least one redirection device located at a stationary position; an energy converter; and at least one elongate connector operatively coupling the at least one buoyant body to the energy converter through the at least one redirection device. In use, the elongate connector transfers motion of the at least one buoyant body resulting from waves in the body of water to the energy converter for conversion into useful energy forms or products.

### FIELD OF THE INVENTION

The present invention relates to a water wave-based energy conversion system that converts the energy of water waves into useful energy forms or products.

### BACKGROUND OF THE INVENTION

The following discussion of the background to the invention is intended to facilitate an understanding of the invention. However, it should be appreciated that the discussion is not an acknowledgement or admission that any of the material referred to was published, known or part of the common general knowledge as at the priority dale of the application.

Water wave-based energy conversion systems extract useful energy from the wave motion of a body of water. Existing arrangements typically include a buoyant body which floats on or just below the surface of the body of water, and an onboard energy converter. The energy converter includes a mechanical component that is moved from the wave directly actuating a water immersed component such as a paddle, blade or wheel, or indirectly actuated through movement of the buoyant body driving movement of an on board device via a tether which is fixed to an external anchor point. The motion of the mechanical component is then converted into useful energy using a power output system.

However, it has been found that existing water wave-based energy conversion systems locate complex equipment in or under water. This increases the capital and maintenance cost of the energy converter and thus increases the cost of energy conversion. This arrangement also makes these energy converters susceptible to catastrophic failure during storm events due to the destructive forces the equipment is exposed to during such storm events.

It would therefore be desirable to provide an alternative or improved water wave-based energy conversion system.

### SUMMARY OF THE INVENTION

According to the present invention, there is provided a water wave-based energy conversion system comprising:
at least one buoyant body capable of floating on or below the surface of a body of water;
an energy converter;
at least one elongate connector operatively coupling the at least one buoyant body to the energy converter; and
at least one redirection device located at a station position, the redirection devices(s) redirecting movement and tension in the elongate connector from one direction to another direction,
wherein, in use, the elongate connector transfers motion of the at least one buoyant body resulting from waves in the body of water through the at least one redirection device to the energy converter for conversion into useful energy forms or products,
and wherein, in use, the effective length of the elongate connector can be varied to suit particular water levels, tidal or weather events.

The water wave energy conversion system of the present invention employs a buoyant body which is situated in a body of water and an energy converter which is geographically separate to the buoyant body. The buoyant body is connected to the energy converter by an elongate connector via a one or a number of redirection devices. The separate location of the energy converter can allow for this component to be located out of the body of water, in a robust enclosure that is weather proofed. This separation can also allow the in-water components of the system to have a simple and robust construction enabling ease of maintenance and repair.

The effective length of the elongate connector can be varied/customised to suit particular water levels, tidal or weather events. The effective length of the elongate connector can be varied in some embodiments, to vary the depth of the buoyant body in the body of water relative to the water surface. Additionally, this enables the buoyant body to be lowered or raised relative to the surface of the body of water to tea the water wave based energy conversion system from damage during storm events.

The buoyant body and energy converter are operatively connected at their separate locations by an elongate connector. The elongate connector can be a cable, rope, chain, tether, cord, wire, or other flexible line, which is preferably resistant to corrosion or other deterioration from submergence in either fresh water or salt water, and having sufficient strength to withstand tension applied during operation of the system. In some embodiments, the elongate connector may include sections of higher strength material interlinked by a flexible connection section. The higher strength material may comprise larger diameter material, solid material, tubular material or the like. In some forms, the higher strength material comprises solid metal sections. The elongate connector is preferably constructed from a material that enables the elongate connector to undergo minimal changes in longitudinal length with changes in applied tensile force. In a preferred form, the elongate connector comprises a cable. The elongate connector may be fitted with at least one buoyancy element for reducing the net weight of the connector in water. The use of buoyancy elements reduces sagging of the elongate connector along its length so as to generally maintain a constant tension therein between the buoyant body and energy converter.

Movement and tension in the elongate connector can be redirected from one direction to another direction using one or more redirection devices. The redirection device can also be used to tether the buoyant body in a generally fixed location in the body of water. The redirection device may be located on a fixed object such as a platform, vessel, mooring or similar. However, in a preferred embodiment, the redirection device is located at an underwater location. The redirection device can have any suitable dimensions or configuration, and may be formed from any suitable material. The redirection device can therefore include an axis about which the longitudinal direction of travel of the elongate connector changes. The redirection device may include a rotary member about which an elongate connector can move. The rotary member can be any suitable rotationally mounted body which facilitates longitudinal movement of the elongate connector about the redirection device, but is preferably a pulley. The redirection device may have additional degrees of freedom to allow the redirection device to move in other directions other than rotationally. In some embodiments, the redirection device may include a rotary member which rotates about an axis about which an elongate connector can move. The rotary member may also be configured to move axially along that axis, and in some cases also laterally pivot relative to the axis. Other degrees of movement such as radial, transverse and other lateral movement are also possible.

The system of the present invention may include a plurality of redirection devices. For example, a further redirection device may be used to redirect the elongate cable from an underwater location to the energy converter. Similarly, further redirection devices can be used to allow the elongate cable to negotiate obstacles above or below the surface of the body of water between the buoyant body and redirection device and/or the redirection device and the energy converter.

A certain tension can be maintained in the elongate connector using a tensioning means to ensure efficient transfer of wave motion from the buoyant body to the energy converter. The tensioning means applies a tension to the elongate connector or connectors between the respective buoyant body and energy converter. Tension may be applied to the elongate connection by applying an opposing force to a portion of the elongate connector. For example, the tensioning mechanism may include a weight or weights secured to an end of the elongate connector. In other forms, a pulley, a resilient member such as a spring, or any other suitable means may be used to create tension in the elongate member. The opposing force is preferably great enough to maintain tension in the elongate connector whilst the buoyant body moves downwards towards a trough of a wave. The tensioning means can be located at any point in the system. It is preferred for the tensioning means to be operatively associated with the energy converter. In some embodiments, the energy converter may include the tensioning means.

The energy converter can be configured to extract more energy from waves moving the buoyant body through the use of a movement limiter. A movement limiter limits movement of the buoyant body in the body of water when a wave passes the buoyant body up to a threshold point. Once the threshold point is surpassed, the buoyant body is allowed to move in the body of water. This may be achieved using a slingshot type mechanism. While the movement limiter can be located at any point in the system, it is preferred for the movement limiter to be operatively associated with the energy converter.

The energy converter converts movement of the elongate member (driven by movement of the buoyant body) into useable energy forms or products. In some embodiments, the energy converter utilises movement of the elongate connector to achieve at least one of the following: produce electrical energy, desalinate water, produce hydrogen gas, or produce pressurised fluid. A number of suitable energy conversion devices are known in the art and it should be understood that the system of the present invention may utilise one or more of these in the energy converter. In one preferred embodiment, the energy converter comprises:
at least one pressure module which uses movement of the elongate connector to pressurise a working fluid; and
at least one output module which converts the pressurised working fluid from the pressure module into useful forms of energy or products.

The energy converter may be fixed to a partially or completely water submerged structure, a structure located above the surface of the water or onshore. Examples include (but are not limited to) an offshore structure, a pier structure, a shore based structure, a buoyant buoy or an underwater structure. In one embodiment, the energy converter is fixed to a shore based structure and the at least one redirection device and at least one buoyant body is located in an offshore location above a seabed, in this embodiment, the elongate connector can be connected between at least one redirection device and the energy converter in a position that runs at least one of above or below the seabed.

The buoyant body can be any body or vessel having sufficient buoyancy to float at or below the surface of the body of water. In some embodiments, the buoyant body comprises a buoy, float or other suitable autonomous floating device. In other embodiments, at least one of the buoyant bodies comprises a water-faring vessel such as a ship, boat, yacht or the like.

A plurality of buoyant bodies may be used to multiply the useful energy or product output of the present invention. A plurality of energy converters may also be used. The buoyant bodies may be operatively connected to at least one energy converter through at least one elongate connector. Each buoyant body may have a separate elongate connector which operatively connects each respective buoyant body to at least one of the energy converters. Preferably, each buoyant body is connected to a single energy converter. Each buoyant body can then be actuated separately by the waves with less consideration to synchronizing wave actuation of each elongate connector on the energy converter.

In some embodiments, each energy converter comprises a pressure module and an output module. The pressure module converts movement of the elongate connector into pressure energy, and the output module converts this pressure energy into useful forms of energy or products. Preferably, each buoyant body is connected to its own pressure module via an elongate connector. Each pressure module could then be connected to one or more output modules. In a preferred form, each pressure module is connected to a common output module which is shared amongst a number of pressure modules.

### BRIEF DESCRIPTION OF THE DRAWINGS

The present invention will now be described with reference to the figures of the accompanying drawings, which illustrate particular preferred embodiments of the present invention, wherein:

FIG. 1 is a schematic layout of a wave-based energy conversion system according to a first embodiment of the present invention.

FIG. 2 is a side view of a wave-based energy conversion system according to a second embodiment of the present invention where the energy converter is located on an offshore structure and the output energy or product is used locally.

FIG. 3 is a side view of a wave-based energy conversion system according to a third embodiment of the present invention where the energy converter is located on an offshore structure and the output energy or product is used remotely.

FIG. 4 is a side view of a wave-based energy conversion system according to a fourth embodiment of the present invention where the energy converter is located on a shore based pier.

FIG. 5 is a side view of a wave-based energy conversion system according to a fifth embodiment of the present invention where the energy converter is located onshore.

FIG. 6 is a side view of a wave-based energy conversion system according to a sixth embodiment of the present invention where the buoyant body comprises a water-faring vessel and the energy converter is located on a fixed structure.

FIG. 7 is one form of a pressure module section of an energy converters used in a wave-based energy conversion system according to the present invention.

FIG. 8 is a schematic diagram of a wave farm wave-based energy conversion system according to the present invention.

FIGS. 9 and 10 are schematic representations of two possible embodiments of the energy converter used in a wave-based energy conversion system according to the present invention.

### DETAILED DESCRIPTION

The present invention relates to a water wave-based energy conversion system for generating useful work from the natural motion of water waves, such as ocean waves. It should be understood that the system may be used in any body of water and that the ocean, shore and offshore and onshore structures illustrated in the drawings are shown for exemplary purposes only.

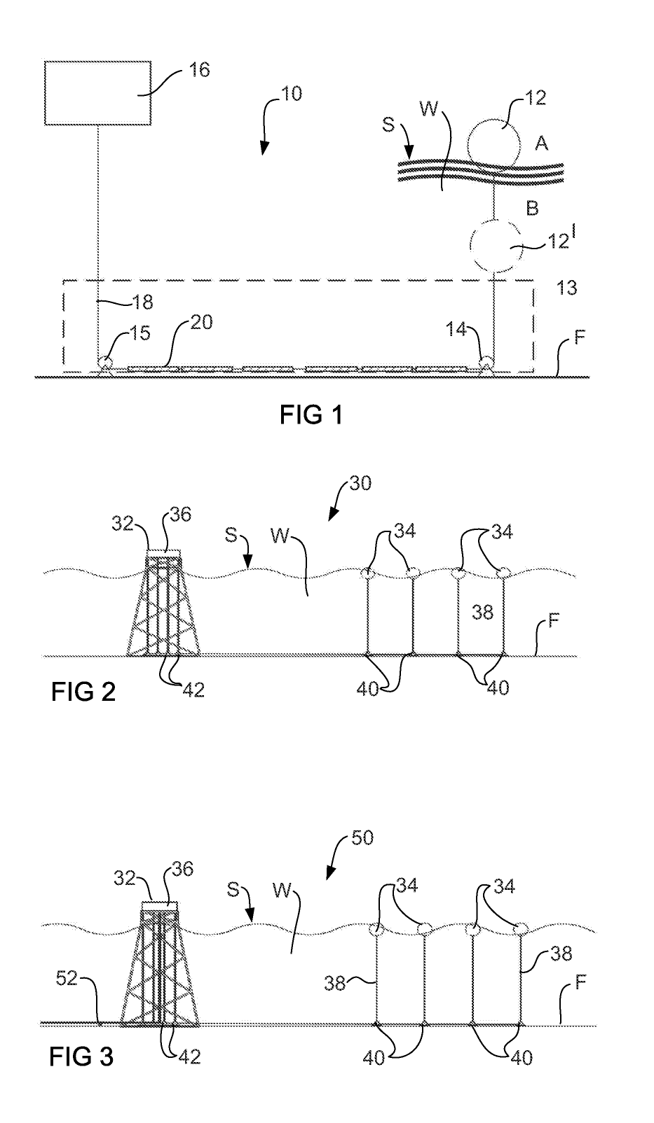

FIG. 1 provides a general schematic of a preferred form of the wave-based energy conversion system of present invention which illustrates the general concept provided by the system. The illustrated system 10 includes at least one buoyant body 12 floating either on or below the water surface S of a body of water W, an underwater redirection device 13, comprising pulleys 14 and 15 which are anchored on an underwater support surface, such as the ocean floor F, an energy converter 16 located at a separate location to the buoyant body 12, and an elongate connector, in this case cables 18 which operatively connect the buoyant body 12 to the energy converter 16, via the pulleys 14 and 15.

The buoyant body 12 is shown in an initial floating position A in FIG. 1. As waves pass the buoyant body 12, the buoyant body 12 will move in response. This movement is transferred to the energy converter 16 via the cables 18. A passing wave will typically cause the buoyant body 12 to rise with respect to the pulleys 14 pulling the cables 18 in a first direction. As the wave passes, the buoyant body 12 will move back to its original position A shown in FIG. 1, and the cables 18 will move in a second (opposite) direction. In the first direction movement of the cables is used by the energy converter 16 to produce useful energy forms or products. A tensioning mechanism (described in more detail below) is used to maintain tension in the cable 18 as the buoyant body 12 drops with the wave during movement in the second direction.

The buoyant body 12 can have any suitable configuration and size having sufficient buoyancy to float at or below the surface of the body of water W. Additionally, the buoyant body 12 is preferably configured to move in a smooth motion with passing waves to maximise actuation of the cables 18, with minimal loss of energy. The buoyant body 12 shown in FIG. 1 has a spherical shape. However, it should be understood that the buoyant body 12 could have a variety of other suitable shapes, such as oval, cylindrical, cubic or similar. The buoyant body 12 may be formed from any suitable buoyant material, such as a foam material. Although shown as having a single buoyant body 12 in FIG. 1, the system 10 may have multiple buoyant bodies, as will be discussed in more detail later in the specification.

The elongate connector shown in FIG. 1 comprises a series of cables 18 which are resistant to corrosion or other deterioration from submergence in either fresh water or salt water, and have sufficient strength to withstand tension applied during operation of the system 10. These cables 18 incorporate a plurality of buoyancy elements 20 fixed along their length. The buoyancy elements 20 are distributed along the length of the cables 18 to reduce the net weight of the cables 18 in the body of water W and thereby minimize any sagging of the cables 18. This is aimed at maintaining a more constant tension in the cables 18 between the buoyant body 12 and the energy converter 16.

The cables 18 are directed through an underwater redirection device 13 which includes pulleys 14 and 15. The pulleys 14 and 15 serve to change the direction of travel of the cables 18 and thereby redirect movement and tension in the cables 18 between the buoyant body 12 and energy converter 16. The redirection device 13 may include any suitable mass that has sufficient mass to anchor the pulleys 14, 15 at a selected location on the ocean floor F. While not illustrated in FIG. 1, the pulleys 14, 15 of the redirection device 13 may include suction anchor devices. It should however be understood that the pulleys 14, 15 may include any type of device or system that fixes the pulleys 14, 15 in a generally stationary position relative to the sea bed.

It should also be understood that the pulleys 14, 15 may have additional degrees of freedom to allow the redirection device to move in other directions other than rotationally. For example, it may be advantageous to allow a rotary member of the pulleys 14, 15 (which rotate about a central axis (not shown) to move axially along that axis, and in some cases also laterally pivot relative to the axis. This would allow the pulleys 14, 15 some movement with tidal and wave motion. Other degrees of movement such as radial, transverse and other lateral movement are also possible.

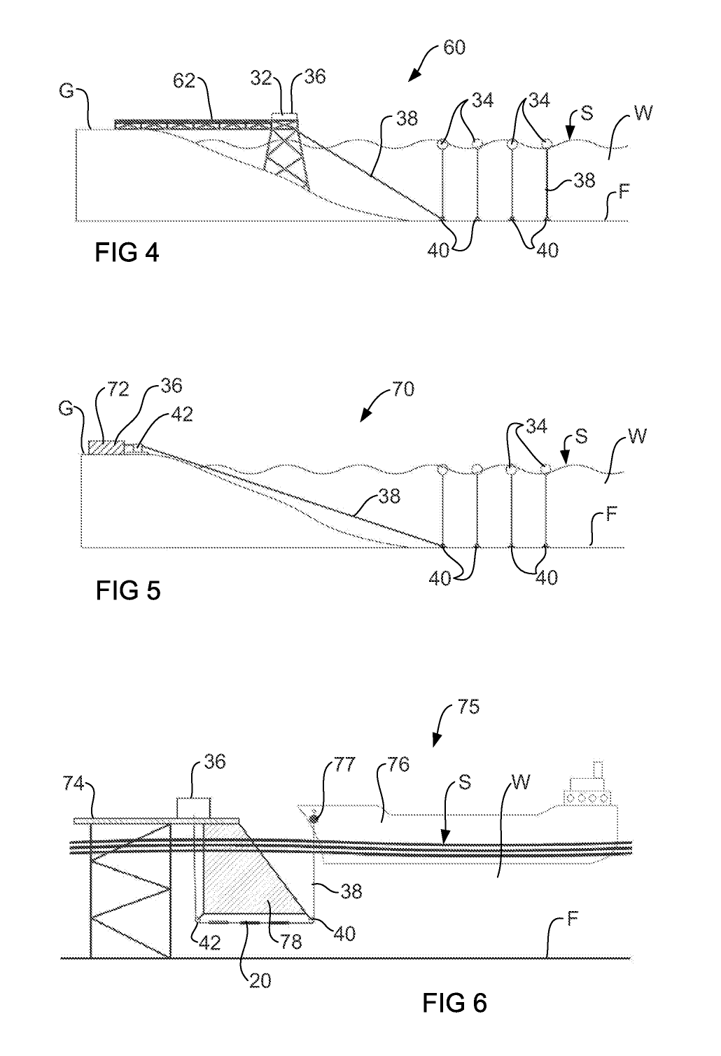

The energy converter 16 is located at a separate location to the buoyant body 12. In some embodiments, the energy converter 16 can be located on an offshore structure (FIGS. 2 and 3), a pier, marina or jetty (FIGS. 4 and 6), a land based structure (FIG. 5) or a vessel (not illustrated). The energy converter 16 converts motion of the buoyant body 12 into useful work, other forms of energy, stored energy or similar. Non limiting examples include an electrical generator for generating electricity which is driven by the reciprocating motion of cables 18, a water pump and/or desalination system. One preferred form of the energy converter 16 is shown in FIGS. 6 to 8, which will be discussed in more detail later in the specification.

The energy converter 16 also includes a tensioning mechanism (not illustrated in FIG. 1) which maintains tension in the cables 18 between the energy converter 16 and the buoyant body 12. The tensioning mechanism provides a constant force in opposition to the force from the buoyant body 12, having a magnitude sufficient to return the system 10 to its equilibrium position after each wave passes the buoyant body 12. The tensioning mechanism may be any device that creates tension in the cables 18. In one form, the tensioning mechanism comprises weight or weights secured to the end of the cables 18.

The energy converter 16 also includes a movement limitation system (not illustrated in FIG. 1) which functions like a ‘slingshot’. As a wave or waves pass the buoyant body 12 and tension builds up on the cables 18, the buoyant body 12 is retarded from movement up until a certain threshold point corresponding to a preselected tension in the cables 18. Once the threshold cable tension is exceeded, the buoyant body 12 is released for free movement (though still held by the cables 18) with the wave(s) in the body of water W. This mechanism increases the buoyancy acting on the buoyant body 12 and hence the tension force acting on the cables 18. The energy converter 16 can thereby extract more energy from the waves.

The illustrated system 10 also incorporates a depth variance system, which enables the depth of the buoyant body 12 in the body of water W to be varied relative to the water surface S. In the illustrated system 10, the variation of the depth of the buoyant body 12 in the body of water is achieved by lengthening or shortening the effective length of the cables 18 between the energy converter 16 and the redirection device 14. This pulls the buoyant body 12 down below the surface S of the body of water W or allows the buoyant body 12 to move upwardly toward the surface S of the body of water W. The depth variance system may be used to pull the buoyant body 12 under the water surface S to avoid damage to the system 10 during high sea states and/or strong wave action. This is illustrated in FIG. 1 with the buoyant body 12′ (in broken lines) in a submerged position B. It may also be used to adjust the elevation of the buoyant body 12 to continuously optimise the energy or product output of the system 10 if the water depth varies, such as during storm surges or tidal variations.

FIG. 2 illustrates an offshore platform embodiment of water wave-based energy conversion system 30 according to the present invention. In the illustrated system 30, the energy or product output of the system 30 is produced on an offshore platform 32 and used locally on the platform 32. The offshore platform 32 could, for example be an existing offshore oil and gas facility where the water wave-based energy conversion system 30 could be used to supplement or replace diesel generator supplied electricity. The water wave-based energy conversion system 30 shown in FIG. 2 includes four buoyant bodies 34 which float on the water surface S, an energy converter 36 housed on the offshore platform 32. The buoyant bodies 34 are connected to the energy converter 36 by cables 38. In this particular embodiment each buoyant body 34 includes a separate cable 38 which runs through respective subsea pulleys 40 and 42 to one or more energy converters 36. Each buoyant body 34 has its own independent set of pulleys because each buoyant body 34 will move out of sync with the others when actuated by waves. The subsea pulleys 40, 42 are fixed relative to the seabed F, by for example, a series of suction anchors. The energy converter 36 converts the buoyancy forces transferred via the cables 38 from the buoyant bodies 34 into a useful energy form or product, for example electricity or desalinated water.

FIG. 3 illustrates another offshore platform embodiment of the water wave-based energy conversion system 50 according to the present invention where the energy or product output of the system 50 is produced on an offshore platform 32 and is then transferred to shore (not illustrated in FIG. 3) via a conduit 52. It should be understood that this system 50 operates in a similar manner as described above in relation to the system 30 illustrated in FIG. 2 and therefore like components in FIG. 3 have been designated with the same reference numerals as used in FIG. 2. The form of the conduit 52 transferring the energy product from the energy converter 36 onshore will depend upon the type of energy or product that is produced on the platform 32. For example, if electrical energy is produced, an electrical subsea cable 52 would be used to transfer the energy to an onshore facility. Alternatively, if desalinated water is produced, a subsea pipeline 52 could be used to transport the water to shore. Alternatively, a conduit 52 may be used to transfer the water to a vessel (not shown in FIG. 3) which could then transport the water to another location.

FIG. 4 shows a pier embodiment of the water wave-based energy conversion system 60 according to the present invention. In this system 60, the energy converter 36 is located on a pier 62. It should be understood that this system 60 operates in a similar manner as described above in relation to the system 30 illustrated in FIG. 2 and therefore like components in FIG. 4 have been designated with the same reference numerals as used in FIG. 2. The water wave-based energy conversion system 60 shown in FIG. 4 includes four buoyant bodies 34 which float on the water surface S, and an energy converter 36 housed on the pier structure 62. The buoyant bodies 34 are connected to the energy converter 36 by cables 38 which run through subsea pulleys 40, 42. The pier structure 62 is fixed at one end to the shore G and extends offshore through the body of water W out towards the buoyant bodies 34.

FIG. 5 illustrates an onshore facility embodiment of the water wave-based energy conversion system 70 according to the present invention. This embodiment operates in a similar manner as described for the system 60 illustrated in FIG. 4, except that the energy converter 36 is housed on an onshore facility 72. It should be understood that the cable 38 between the pulleys 40 and shore G could either run above the seabed/land as shown in FIG. 5 or underground below the seabed/land.

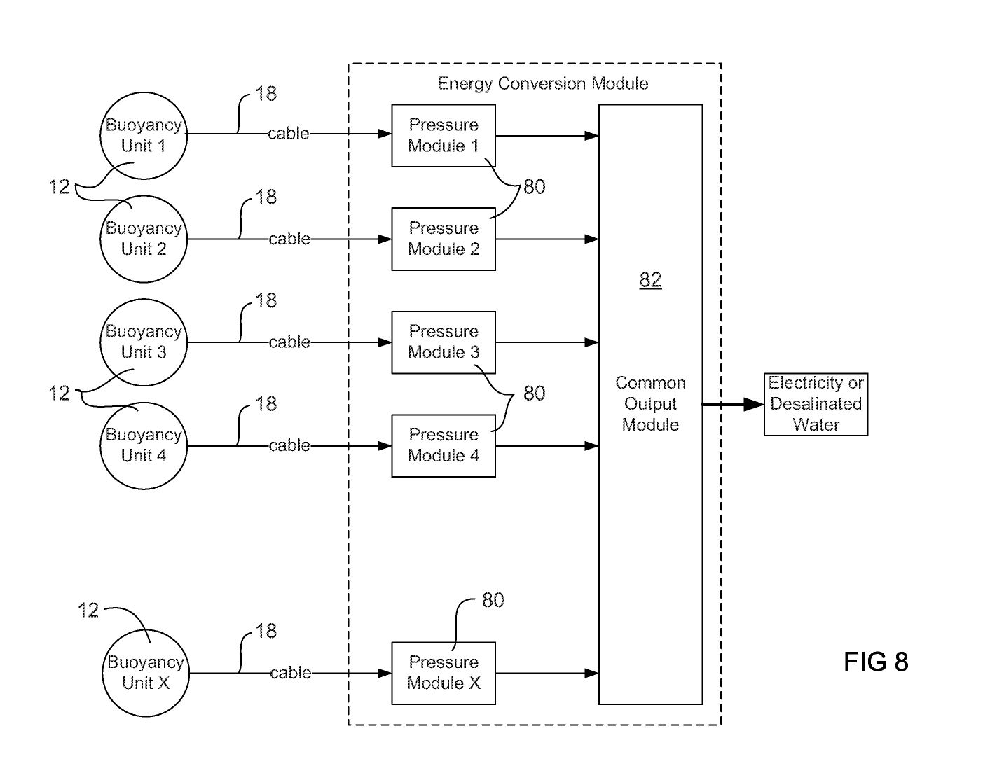

Although the systems 30, 50, 60 and 70 shown in FIGS. 2 to 5 have four buoyant bodies 34, it should be understood that any desired number of buoyant bodies 34 may be used, and that the four buoyant bodies 34 are shown in FIGS. 2 to 5 for exemplary purposes only. For large scale energy or product generation, a plurality of the buoyant bodies 34, elongate connectors 38 and energy converters 36 can be employed in a ‘wave farm’ concept to multiply the useful energy or product output of the water wave-based energy conversion system of the present invention. An example of one such system is shown in FIG. 8.

FIG. 6 shows another embodiment of water wave-based energy conversion system 75 according to the present invention where the buoyant body comprises a water-faring vessel 76 such as a ship and the energy converter 36 is located on a fixed structure 74 such as a jetty or marina. It should be understood that this system 75 operates in a similar manner as described above in relation to the system 30 illustrated in FIG. 2 and therefore like components in FIG. 4 have been designated with the same reference numerals as used in FIG. 2.

The water wave-based energy conversion system 75 shown in FIG. 6 utilises the water-faring vessel 76 as the buoyant body floating on the water surface S, and an energy converter 36 housed on the fixed structure 74. The water-faring vessel 76 is moored to the fixed structure 74 and also connected to the energy converter 36 by cables 38 which run through subsea pulleys 40, 42. The subsea pulleys 40, 42 are mounted on a truss structure 78 which fixes the pulleys 40, 42 in a substantially stationary position relative to the fixed structure 74. Accordingly, movement of the water-faring vessel 76 can be used to generate energy or energy dependent products which in turn may be used on the water-faring vessel 76. A marker buoy 77 is provided on the cable near the connection end to the water-faring vessel 76 to maintain that end of the cable 38 at the waters surface S to enable the water-faring vessel 76 to arrive at the fixed structure and easily locate and attach the water-faring vessel 76 to the cable 18.

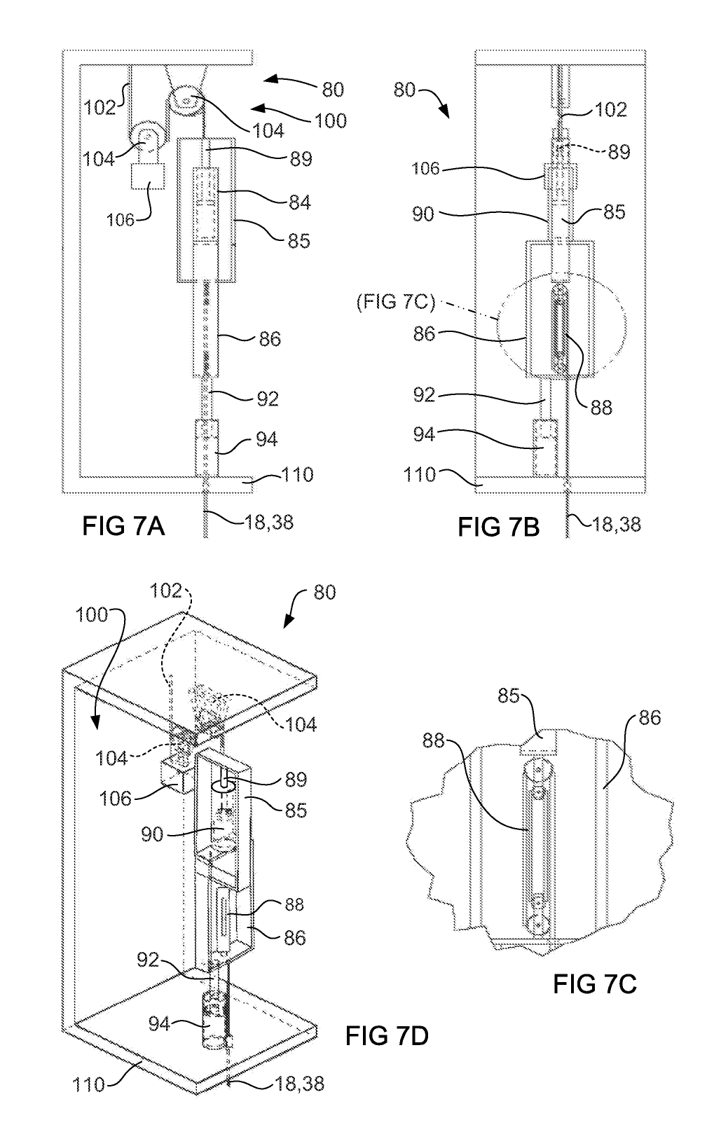

Referring now to FIGS. 7 to 10, there is shown one preferred form of the energy converter 16, 36 used in the systems 10, 30, 50, 60, 70 and 75 shown in FIGS. 1 to 6. The energy converter 16, 36 converts the mechanical energy from movement of the buoyant body(s) 12, 34 (transferred to the energy converter 16, 36 via the cables 18, 38) into useable energy forms or products.

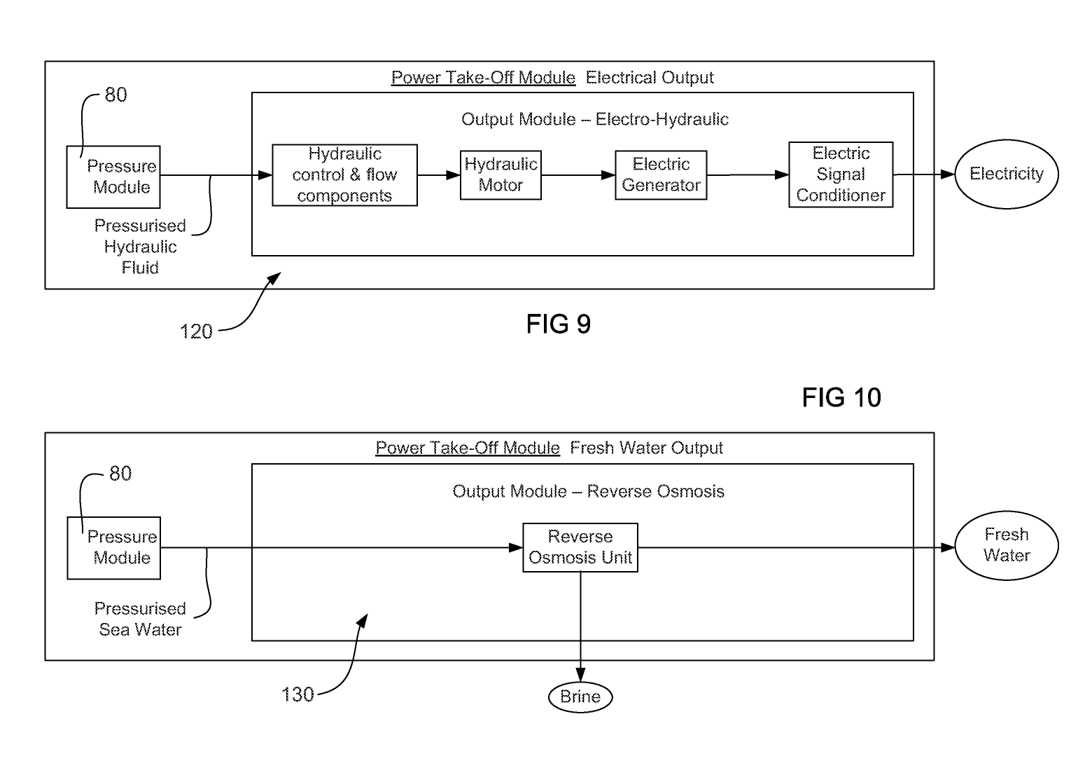

The energy converter 16, 36 illustrated in FIGS. 7 to 10 comprises a pressure module 80 (FIG. 7) and an output module 82 (FIG. 8), 120 (FIG. 9), 130 (FIG. 10). It should be appreciated that the energy converter 16, 36 can comprise one or more pressure modules 80 and one or more connected output modules 82. It should also be appreciated that other forms of energy converter could be used. For example, one possible embodiment (not illustrated) of the energy converter comprises a linear electric generator/counterweight system which converts the energy from the cable tension directly into electrical energy.

Referring to FIG. 8, it can be seen that the pressure module 80 utilises the mechanical energy of the input force from movement of the cables 18, 38 to pressurise a working fluid. Possible examples of working fluids include, but are not limited to, hydraulic fluid and sea water. The output module 82 converts the pressurised fluid from the pressure module 80 into useful energy forms or products. In the system shown in FIG. 8, multiple buoyant bodies 12 are individually connected to one of a number of pressure modules 80 via separate cables 18. It is important that each of the buoyant bodies 12 is connected to an individual pressure module 80 to account for the differences in wave actuation on each buoyant body 12. In most cases, each buoyant body 12 would be actuated out of sync with at least one, and most likely most of the other buoyant bodies 12. The pressurised fluid output of each of these pressure modules 80 are fed into a common output module 82.

One preferred embodiment of the pressure module 80 part of the energy converter 16, 36 is shown in FIG. 7. Referring to FIG. 7, it can be seen that pressure module 80 comprises a pulley arrangement that drives motion of a piston 84. The pressure module 80 includes a piston arm box 85 and a piston cylinder box 86, each comprising a support structure connected to the piston arm 89 and the piston cylinder 90 of the piston 84. The piston arm box 85 is connected to the piston arm 89 (the piston arm 89 is fixed to the top of the piston arm box) and to one end of the cables 18, 38. The piston cylinder 90 is fixed to the top of the piston cylinder box 86. The piston cylinder box 86 is fixed in place within the pressure module 80 on a support strut 92 which includes an elevation actuator 94 (described in more detail below). The piston arm box 85 is movable within the pressure module 80, and can drive reciprocal movement of the piston arm 89 through movement of the cables 18, 38. Movement of the piston arm box 85 pressurises a fluid medium in the piston cylinder 90. This pressurised fluid is the useful output of the pressure module 80, which is further utilised in an output module 82.

The piston arm box 85 also includes a pulley system 88 which connects to an end of piston cylinder box 86 to drive movement of the piston arm box 85. The pulley system 88 is geared to a fixed ratio to provide a reduction in travel of the piston arm box 85 relative to travel of the cables 18, 38. Hence, the piston arm box 85 moves with a reduced linear displacement, relative to the displacement of the input cables 18, 38.

The elevation actuator 94 is mounted between one end to the piston cylinder box 86 and the base frame 110 of the pressure module 80. The length of the elevation actuator 94 can be varied to raise or lower the piston cylinder box 86 relative to the base frame 110. Adjustment of this length can be used to change the average tension on the input cables 18, 38.

The piston arm box 85 is also connected to a tensioning mechanism 100. The illustrated tensioning mechanism 100 includes a cable 102, two pulleys 104 and a counterweight 106. The counterweight provides a constant force in opposition to the force from the buoyant body 12, 34. The force provided by the counter weight 106 acts to return the wave-based energy conversion system of present invention to its equilibrium position (for example, position A of the buoyant body shown in FIG. 1). In other embodiments, the tensioning mechanism may include a return spring system.

FIGS. 9 and 10 show two possible embodiments of output module 120, 130 which can be used coupled with the pressure module 80 shown in FIG. 7 to convert the pressurised fluid from the pressure module 80 into useful energy forms or products. Possible embodiments include, but are not limited to, hydraulic, electric and mechanical systems or a mixture of these systems. FIG. 9 illustrates an electro-hydraulic output module 120. FIG. 10 illustrates a reverse osmosis output module 130.

Referring firstly to the electro-hydraulic output module 120 of FIG. 9, it can be seen that the pressurised hydraulic fluid output from the pressure module 80 is fed into a hydraulic control and flow system and then into a hydraulic motor. The hydraulic motor converts the pressure of the hydraulic fluid into the mechanical rotary energy of a motor shaft. This mechanical rotary energy can then be optionally fed through a mechanical gearbox to increase or decrease the rotational speed of the shaft (not illustrated). The output shaft of the hydraulic motor (or gearbox) is connected to an electrical generator which converts the rotational energy of the hydraulic motor (or gearbox) into electrical energy. Depending on the electrical output required, the electrical output from the generator may be fed into an electrical signal conditioner which converts the electrical signal into the required form. The electrical output of the system can be used to produce a multitude of possible energy carrying products. In one embodiment, a fuel cell could be used to produce hydrogen gas.

Referring now to the reverse osmosis output module 130 of FIG. 10, it can be seen that pressurised sea water output from the pressure module 80 is fed into the inlet of the output module 130. The output module 130 employs a reverse osmosis process to convert the pressurised seawater into desalinated fresh water and brine. The module 130 may also include pre-treatment and post-treatment stages of the fluid being inputted and outputted from the module 130.

Those skilled in the art will appreciate that the invention described herein is susceptible to variations and modifications other than those specifically described, it is understood that the invention includes all such variations and modifications which fall within the spirit and scope of the present invention.

Where the terms “comprise”, “comprises”, “comprised” or “comprising” are used in this specification (including the claims) they are to be interpreted as specifying the presence of the stated features, integers, steps or components, but not precluding the presence of one or more other feature, integer, step, component or group thereof.

1. A water wave-based energy conversion system comprising:
at least one buoyant body capable of floating on or below the surface of a body of water;
an energy converter;
at least one elongate connector operatively coupling the at least one buoyant body to the energy converter; and
at least one redirection device located at a stationary position, the redirection device(s) redirecting movement and ten ion in the elongate connector from one direction to another direction,
wherein, in use, the elongate connector transfers motion of the at least one buoyant body resulting from waves in the body of water through the at least one redirection device to the energy converter for conversion into useful energy forms or products,
and wherein, in use, the effective length of the elongate connector can be varied to suit articular water levels tidal or weather events.

2. A water wave-based energy conversion system according to claim 1, wherein the at least one redirection device is located at an underwater location.

3. A water wave-based energy conversion system according to claim 1, wherein each redirection device includes an axis about which the longitudinal direction of travel of the elongate connector changes and the elongate connector can move.

4. A water wave-based energy conversion system according to claim 3, wherein the redirection device includes a rotary member about which an elongate connector can move.

5. A water wave-based energy conversion system according to claim 4, wherein the redirection device includes a pulley which facilitates longitudinal movement of the elongate connector about the redirection device.

6. A water wave-based energy conversion system according to claim 1, further comprising a tensioning means for applying tension to the elongate connector or connectors between the respective buoyant body and energy converter.

7. A water wave-based energy conversion system according to claim 6, wherein the tensioning means is operatively associated with the energy converter.

8. A water wave-based energy conversion system according to claim 7, wherein the tensioning means provides an opposing force to a portion of the elongate connector proximate the energy converter, the opposing force being great enough to maintain tension in the elongate connector whilst the buoyant body moves downwards towards a trough of a wave.

9. A water wave-based energy conversion system according to claim 1, further including a movement limiter which limits movement of the buoyant body in the body of water when a wave passes the buoyant body up to a threshold point, and then allows movement of the buoyant body in the body of water once the threshold point is surpassed, thereby enabling the energy converter to extract more energy from the wave.

10. A water wave-based energy conversion system according to claim 9, wherein the movement limiter is operatively associated with the energy converter.

11. A water wave-based energy conversion system according to claim 1, wherein the elongate connector is fitted with at least one buoyancy element for reducing the net weight of the connector in the body of water.

12. A water wave-based energy conversion system according to claim 1, wherein the elongate connector comprises a cable.

13. A water wave-based energy conversion system according to claim 1, wherein variation in the effective length of the elongate connector enables the buoyant body to be lowered or raised relative to the surface of the body of water to protect the water wave based energy conversion system from damage during weather events.

14. A water wave-based energy conversion system according to claim 1, wherein the energy converter utilises movement of the elongate connector to achieve at least one of the following: produce electrical energy, desalinate water, produce hydrogen gas, or produce pressurised fluid.

15. A water wave-based energy conversion system according to claim 1, wherein the energy converter comprises:
at least one pressure module which uses movement of the elongate connector to pressurise a working fluid; and
at least one output module which converts the pressurised working fluid from the pressure module into useful forms of energy or products.

16. A water wave-based energy conversion system according to claim 1, wherein the energy converter is fixed to a structure above water or a partially or completely water submerged structure.

17. A water wave-based energy conversion system according to claim 1, wherein at least one of the buoyant bodies comprises a water faring vessel.

18. A water wave-based energy conversion system according to claim 1, including a plurality of buoyant bodies.

19. A water wave-based energy conversion system according to claim 18, including a plurality of energy converters.

20. A water wave-based energy conversion system according to claim 19, wherein each buoyant body includes a separate elongate connector which operatively connects each respective buoyant body to at least one of the energy converters.
